(19) United States
(12) Patent Application Publication
(10) Pub. No.: US 2006/0234759 A1
(43) Pub. Date: Oct. 19, 2006

(54) Apparatus and method for processing a function execution recommendation alarm event in wireless terminal

(75) Inventors: Jae-Ho Kim, Gumi-si (KR); Jeong-Wook Seo, Suseong-gu (KR); Hyun-Ji Kim, Gumi-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/356,981

(22) Filed: Feb. 21, 2006

(30) Foreign Application Priority Data
Feb. 21, 2005 (KR) 2005-14244
Feb. 6, 2006 (KR) 2006-11134

(51) Int. Cl. H04M 1/00

(52) U.S. Cl. 455/550.1

(57) ABSTRACT

Disclosed are an apparatus and method for processing function events in a wireless terminal. The apparatus includes a memory for storing a character UI image according to the function events of the wireless terminal; an event collection section for collecting the function events occurring in the wireless terminal, and generating event messages for identifying the function events; an agent control section for including a plurality of specialists for processing the function events, determining a specialist corresponding to the event message among the specialists, selecting and outputting a character UI ID based on the function event of the determined specialist, and processing received user feedback information on a corresponding event according to the user feedback information; and an agent expression section for outputting a character image and text corresponding to the function event and the feedback information.

### PRIORITY

This application claims the benefit under 35 U.S.C. § 119(a) of an application entitled “Apparatus and Method for Processing Function Execution Recommendation Alarm Event in Wireless Terminal,” filed in the Korean Intellectual Property Office on Feb. 21, 2005 and assigned Serial No. 2005-14244, and an application entitled “Apparatus and Method for Processing Function Execution Recommendation Alarm Event in Wireless Terminal,” filed in the Korean Intellectual Property Office on Feb. 6, 2006 and assigned Serial No. 2006-11134, the entire disclosures of which are hereby incorporated by reference.

### BACKGROUND OF THE INVENTION

1. Field of the Invention

The present invention relates to an apparatus and a method for an agent in a wireless terminal. More particularly, the present invention relates to an apparatus and a method for performing a character agent function, thereby processing an alarm event for recommending the execution of functions frequently used at a specific time or on a specific day.

2. Description of the Related Art

Today, wireless terminals are being developed into terminals capable of performing a high speed data transmission and a voice communication function. For example, if an International Mobile Telecommunications-2000 (IMT-2000) mobile communication network is constructed, it is possible to perform high speed data communication as well as voice communication by means of a wireless terminal. Data processed by a wireless terminal capable of performing data communication may include packet and image data. Recently, a short message service and a wireless Internet service have been provided. Such a short message service has not only been used as a simple communication tool, but also as a marketing and customer management tool. Further, wireless Internet mail has been provided, so that it is possible to transmit/receive various wireless network mail messages. As the functionality of a wireless terminal has expanded beyond simple wireless communication, it has also come to include separate camera, multimedia playback, game, and schedule management functions. Such supplementary functions are expanding their utility with the improvement of a display window of a wireless terminal and the realization of high speed communication. Today, people organize their schedules on a daily, weekly and monthly basis due to busy professional and personal lives. This can be done using the supplementary functions of a wireless terminal as described above.

As a wireless terminal has come to include various functions as described above, the wireless terminal may be used as a hybrid service system. However, users have not yet efficiently used the various functions of the wireless terminal due to the complexity of the User Interface (UI).

Accordingly, there is a need for an improved apparatus and method for increased efficiency in various display schemes which allow users to easily recognize the various supplementary functions and the status of a wireless terminal by means of visual user data such as photo data, characters and animation.

### SUMMARY OF THE INVENTION

An aspect of exemplary embodiments of the present invention is to address at least the above problems and/or disadvantages and to provide at least the advantages described below. Accordingly, exemplary embodiments of the present invention have been made to solve the above-mentioned problems occurring in the prior art, and it is an object of embodiments of the present invention to provide an apparatus for setting an alarm, which is used for recommending the execution of functions frequently used at a specific time, through a character agent function.

It is another object of embodiments of the present invention to provide an apparatus for displaying an alarm, which is used for recommending the execution of functions frequently used at a specific time, through a character agent function.

It is further another object of embodiments of the present invention to provide a method for setting an alarm, which is used for recommending the execution of functions frequently used by a user at a specific time, under the control of a controller in a wireless terminal.

It is still another object of embodiments of the present invention to provide a method for displaying an alarm, which is used for recommending the execution of functions frequently used by a user at a specific time, under the control of a controller in a wireless terminal.

In order to accomplish the aforementioned objects, according to one aspect of the present invention, there is provided an apparatus for processing function events in a wireless terminal. The apparatus includes a memory for storing a character UI image according to the function events of the wireless terminal; an event collection section for collecting the function events occurring in the wireless terminal, and generating event messages for identifying the function events; an agent control section for including a plurality of specialists for processing the function events, determining a specialist corresponding to the event message among the specialists, selecting and outputting a character UI ID based on the function event of the determined specialist, and processing received user feedback information on a corresponding event according to the user feedback information; and an agent expression section for outputting a character image and a text corresponding to the function event and the feedback information.

In order to accomplish the aforementioned objects, according to another aspect of the present invention, a method for processing function events in a wireless terminal is provided. The method includes the steps of, when function execution events occur in the wireless terminal, executing a corresponding function; storing function execution information, which is generated during the execution of the corresponding function, in a function execution list; analyzing the function execution list, and determining if the function has been executed more than a predetermined number of times within a specific time period in each predetermined cycle; and when the function has been executed more than the predetermined number of times within the specific time period in each predetermined cycle, setting an alarm for recommending an execution of the corresponding function if the corresponding function is not executed within a specific time period in each next predetermined cycle.

In order to accomplish the aforementioned objects, according to further another aspect of exemplary embodiments of the present invention, a method for processing a function alarm event in a wireless terminal is provided. The method includes the steps of, when the alarm event occurs, checking the type of functions set in the alarm event; analyzing an execution history of the corresponding checked function and determining if the corresponding function has been executed within a specific time period; and when the corresponding function has not been executed within the specific time period, expressing a character and a text for recommending an execution of the corresponding function.

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other objects, features and advantages of exemplary embodiments of the present invention will be more apparent from the following description taken in conjunction with the accompanying drawings, in which:

FIG. 1 is a block diagram illustrating the construction of a wireless terminal according to an exemplary embodiment of the present invention;

FIG. 2 is a block diagram illustrating the function blocks of a controller in a wireless terminal according to an exemplary embodiment of the present invention;

FIG. 3 is a flowchart illustrating an operation for establishing a message communication-recommendation-alarm by a character agent according to an exemplary embodiment of the present invention;

FIG. 4 is a flowchart illustrating an operation for processing a message communication-recommendation-alarm event by a character agent according to an exemplary embodiment of the present invention;

FIG. 5 is a flowchart illustrating an operation for establishing a mail communication-recommendation-alarm by a character agent according to an exemplary embodiment of the present invention;

FIG. 6 is a flowchart illustrating an operation for processing a mail communication-recommendation-alarm event by a character agent according to an exemplary embodiment of the present invention;

FIG. 7 is a flowchart illustrating an operation for establishing a ringing sound change-recommendation-alarm by the character agent according to an exemplary embodiment of the present invention;

FIG. 8 is a flowchart illustrating an operation for processing a ringing sound change-recommendation-alarm event by a character agent according to an exemplary embodiment of the present invention;

FIG. 9 is a flowchart illustrating an operation for establishing a function execution-recommendation alarm of a wireless terminal according to an exemplary embodiment of the present invention;

FIGS. 10a and 10b are flowcharts illustrating an operation for executing the functions applied to FIG. 9;

FIG. 11 is a flowchart illustrating an operation for processing a function execution-recommendation alarm event of a wireless terminal according to an exemplary embodiment of the present invention;

FIG. 12 is a diagram illustrating an operation for recommending an execution of a communication function according to an exemplary embodiment of the present invention;

FIG. 13 is a diagram illustrating an operation for recommending an execution of a message function according to an exemplary embodiment of the present invention;

FIG. 14 is a diagram illustrating an operation for recommending an execution of a mail function according to an exemplary embodiment of the present invention;

FIG. 15 is a diagram illustrating an operation for recommending an execution of an application program function according to an exemplary embodiment of the present invention;

FIG. 16 is a diagram illustrating an operation for recommending an execution of a ringing sound function according to an exemplary embodiment of the present invention; and

FIG. 17 is a diagram illustrating an operation for recommending an execution of a morning call function according to an exemplary embodiment of the present invention.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize the various changes and modifications of the embodiments described herein can be made without departing from the scope and spirit of the invention. Also, descriptions of well-known functions and constructions are omitted for clarity and conciseness.

In the description below, an alarm event may be a type of timer event. An alarm may have the same meaning as that of an alarm event. A timer event is characterized by the instant the current time reaches some preset future time. Further, a function execution may have the same meaning as that of an event occurrence.

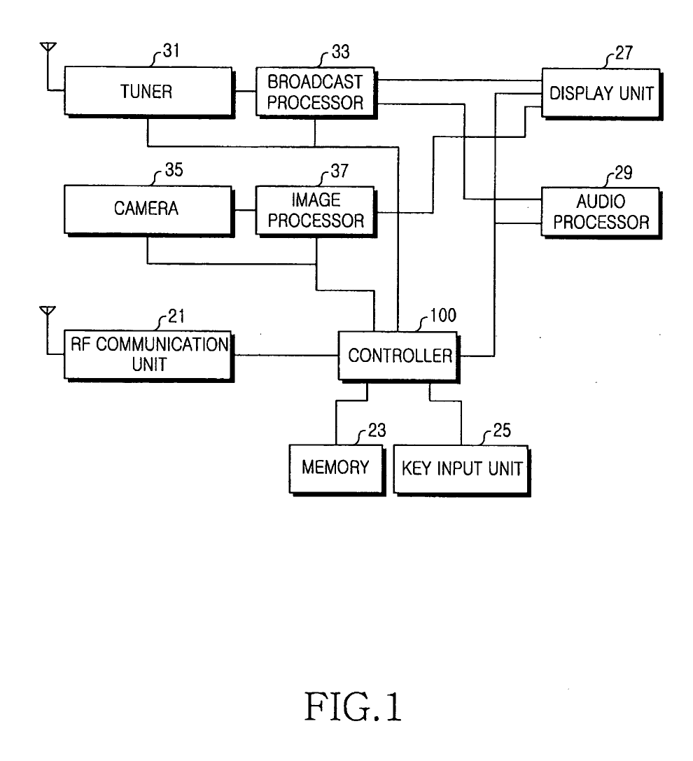

FIG. 1 is a block diagram illustrating the construction of a wireless terminal for expressing character agents based on events occurring therein according to an exemplary embodiment of the present invention. Referring to FIG. 1, a Radio Frequency (RF) communication unit 21 performs a wireless communication function of a wireless terminal. The RF communication unit 21 includes an RF transmitter (not shown) for up-converting and amplifying a frequency of transmitted signals and an RF receiver (not shown) for low-noise amplifying and down-converting a frequency of the received signals.

A key input unit 25 includes various functional keys for inputting number and character information and function keys for establishing various functions. The key input unit 25 includes keys for controlling character agents according to events based on the embodiment of the present invention.

A memory 23 may include a program memory and a data memory. The program memory stores programs for processing a call of the wireless terminal. The program memory also stores programs for controlling an agent expression based on the execution of a function (event) occurring according to one embodiment of the present invention. Further, the program memory stores programs for controlling an agent expression based on the setup and processing of a message/mail communication-recommendation-alarm, and programs for controlling an agent expression based on the setup and processing of a ringing sound-change-recommendation-alarm. The data memory temporarily stores data occurring while performing operations of the wireless terminal. Further, the data memory includes a character memory for storing character images for an agent expression according to an exemplary embodiment of the present invention. The character memory may function as a file system and may include indices of a memory (or file system) according to characters. The character memory may be constructed in various types in order to express movements, expressions and objects, which are details of each character. That is, character information stored in the character memory may be stored according to characters capable of performing an agent expression. Further, the data memory includes a text memory for storing texts for an agent expression. The text memory may store corresponding texts according to occurring events or feedback. Further, the text memory may store ringing sound data, e-mail address data, game data, phone number (phone book) list information, and functions (events), which have occurred in a function execution (event occurrence), according to corresponding types. For example, if a communication function is performed, the text memory stores information used for the execution of the communication function in a call history log. If a mail function is performed, the text memory stores information used for the execution of the mail function in a mail history log.

The controller 100 controls general operations of the wireless terminal. The controller 100 includes both a modem for modulating and demodulating signals and a codec for coding and decoding signals. Accordingly, the controller 100 codes and modulates transmission signals, and demodulates and decodes received signals. The controller 100 may be a Mobile Station Modem (MSM) chip. The controller 100 controls operations of a communication mode, a camera mode and a broadcasting reception mode according to mode selection performed by a user. Herein, a data processor including the modem and the codec, which are separated from the controller 100, may also be disposed between the RF communication unit 21 and the controller 100. The controller 100 collects events based on the operations of the wireless terminal, controls agents based on the collected events, and expresses the processing and status of an event by means of an agent according to the exemplary embodiment of the present invention. Herein, the agent may be expressed by means of a corresponding character and text selected from the memory 23. Further, it is possible to display characters and texts corresponding to feedback.

A camera 35 is driven by the controller 100 when a camera mode is selected by a user. The camera 35 photographs an object and generates image signals for the photographed object.

An image processor 37 scales the image signals received from the camera 35 according to the size of a display unit 27, and displays the image signals through the display unit 27. In a storage mode, the image processor 37 codes the image signals by a preset coding scheme and stores the coded image signals. In a reproduction mode of received or stored image data, the image processor 37 decodes coded image data.

A tuner 31 selects and receives broadcast signals of a preset channel under the control of the controller 100 in a broadcast reception mode. A broadcast processor 33 demodulates and decodes the broadcast signals received in the tuner 31 and outputs image signals to the display unit 27 and audio signals to an audio processor 29. The broadcast signals may include satellite broadcast signals or terrestrial broadcast signals.

The display unit 27 may display menus according to the operations of the wireless terminal under the control of the controller 100. When an event occurs, the display unit 27 displays a character output according to the event. Further, the display unit 27 displays the image signals output from the image processor 37 or the broadcast processor 33 in the camera mode or the broadcast reception mode.

In a communication mode, the audio processor 29 processes audio signals generated in the communication mode under the control of the controller 100. In the camera mode, the audio processor 29 processes audio signals generated from the camera photographing under the control of the image processor 37. In the broadcast reception mode, the audio processor 29 processes received broadcast audio signals under the control of the broadcast processor 33.

In the wireless terminal having the construction as described above, it is possible to omit the elements for processing the camera and/or broadcast signals. Even in this case, it is possible to perform a character agent function for events according to one embodiment of the present invention.

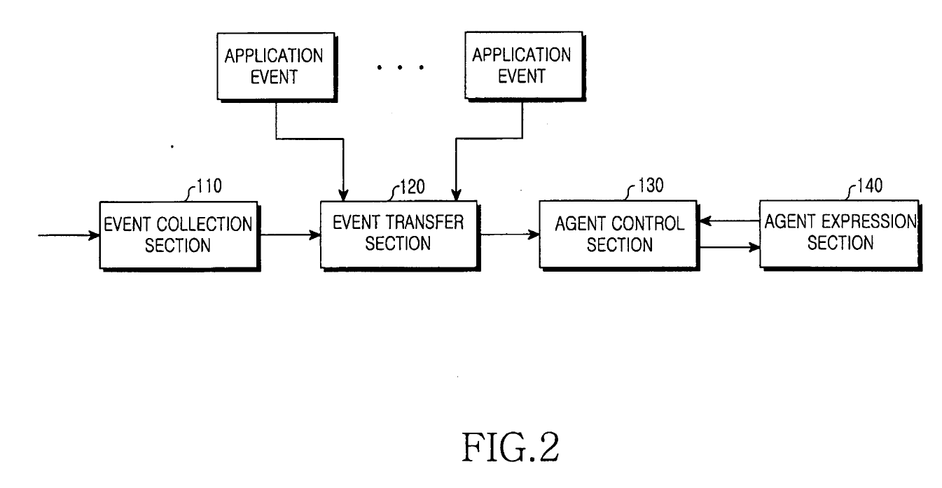

FIG. 2 is a block diagram illustrating the function blocks of the controller in the wireless terminal according to one embodiment of the present invention. For example, the controller 100 of the wireless terminal as illustrated in FIG. 2 may have a construction disclosed in Korean patent application No. 2004-78470 entitled “Intelligent Terminal Using an Artificial Intelligence Agent.” Hereinafter, the present invention will be described with reference to the content disclosed in Korean patent application No. 2004-78470, which is expressly incorporated by reference herein. Further, the controller 100 can realize an embodiment of the present invention by controlling a single agent system, even without providing the controller 100 with function blocks divided into an event collection section, an event transfer section, an agent control section and an agent expression section.

Referring to FIG. 2, the event collection section 110 collects events occurring in the wireless terminal. The events include all possible events which may occur in the wireless terminal. For example, the events include events occurring at a user's request, such as a communication function-execution event, a message function-execution event, a mail function-execution event, a ringing sound function-execution event, a morning call function-execution event and a program function-execution event of the wireless terminal. The collected events also include events occurring according to the implementation of the multimedia function of the wireless terminal. For example, the events collected by the event collection section 110 are events defined in the wireless terminal. When an event has occurred, the event collection section 110 generates an event message as information for identifying the occurred event, and provides the event message to the event transfer section 120.

The event transfer section 120 transfers the event message provided from the event collection section 110 to a corresponding client. In the embodiment of the present invention, the event transfer section 120 preferably transfers the event message to the agent control section 130. However, the event transfer section 120 may also transfer the event message to other elements intended for reception of the event message. Further, the event transfer section 120 receives user-defined events which were not defined in the wireless terminal in addition to the events collected in the event collection section 110, and transfers the received user-defined events to the agent control section 130. Hereinafter, the user-defined event will be referred to as an application event. The application events may include events occurred by a game, another application program or a web service program.

If an event message is received from the event transfer section 120, the agent control section 130 stores the received event message in an internal buffer, analyzes the event message, and determines a User Interface (UI) in order to express a corresponding character agent. The event message transferred from the event transfer section 120 may be the events (the events collected by the event collection section 110) of the wireless terminal and the application events. The following description will be given with a focus on an agent expression of an event collected by the event collection section 110. The agent control section 130, which includes a plurality of specialists, controls the specialists, selects a specialist corresponding to an occurred event, and performs an agent control function. When an event occurs, the agent control section 130 notifies proper specialists of the occurrence of the event according to the received event, and transmits a request for UI information to an agent expression section 140 in order to display the agent expression of the finally selected specialist. Further, the agent control section 130 processes received user feedback information on a corresponding event according to feedback information received from the agent expression section 140.

The agent expression section 140 displays a character expression for the corresponding event according to agent UI information output from the agent control section 130. Herein, the agent expression section 140 manages a plurality of avatar UIs to be displayed on the display unit 27, and controls the display of a corresponding avatar according to the UI information requested by the agent control section 130. If a user generates feedback information in a state of displaying the avatar according to the occurred event, the agent expression section 140 transmits the received feedback information to the agent control section 130. The agent control section 130 performs agent control according to the user feedback information received from the agent expression section 140.

In the construction of FIG. 2, when only the event of the wireless terminal collected by the event collection section 110 is processed, the event transfer section 120 may be omitted. The internal buffer of the agent control section 130 will be referred to as a blackboard.

Hereinafter, the construction and operation of the agent control section 130 will be described in more detail. The agent control section 130 includes a plurality of specialists, a blackboard, a supervisor, an avatar numerical value storage part, a specialist manager, etc. Each specialist is called according to events, performs preset specialized work, and outputs the results. The blackboard stores various information including information of event messages. When the specialists output effective results, the supervisor selects one of the specialists. The avatar numerical value storage part stores numerical values of avatars (characters) according to occurred events. Further, the specialist manager selects corresponding specialists from a specialist list according to events when events occur, and controls an agent according to the events.

The specialist represents a specialist for contributing to solving problems, stores an answer of an intermediate step in the blackboard based on an expertise in a specific field, and simultaneously expresses priority and user preference for the answer of the intermediate step. Further, each specialist understands the status of the blackboard, computes the priority and user preference, and stores the answer of the intermediate step in the blackboard.

The blackboard represents a work place and an information space used when the specialists communicate with one another, and basically enables the specialists to store the answer of the intermediate step in the blackboard. There are many advantages of a blackboard pattern. First, it is possible to easily integrate different types of specialists; next, since specialists have little influence on each other, the specialists may be independently modularized and developed; and last, it is possible to flexibly cope with various changes (an algorithm change of specialists, an addition of a new specialist, etc.).

When two or more specialists are selected for one event, the specialist manager requests the supervisor to select a specialist most relevant to the received event. Then, the supervisor analyzes data of the blackboard, priority and user preference according to events, etc., and selects the specialist most relevant to the received event.

Herein, the character numerical value is altered by various events occurring from the wireless terminal, the agent function, and the feedback of a user. In addition, various application events capable of using the character numerical value have influence on the character numerical value. Further, as an internal numerical value changes, a character interface also changes, and an avatar grows as time goes by. This corresponds to a growth concept for a character (avatar). The wireless terminal according to the embodiment of the present invention introduces a character (avatar) growth based on an artificial intelligence agent system. Consequently, in the embodiment of the present invention, a proposal for various actions is provided to a user on the in accordance with various events occurring in the wireless terminal, so that it is possible to enable the user to effectively use the wireless terminal according to interest. Further, the image of a character and the content of a text are differently expressed, and the numerical value of a character is also altered according to these events and feedback actions of a user based on the events.

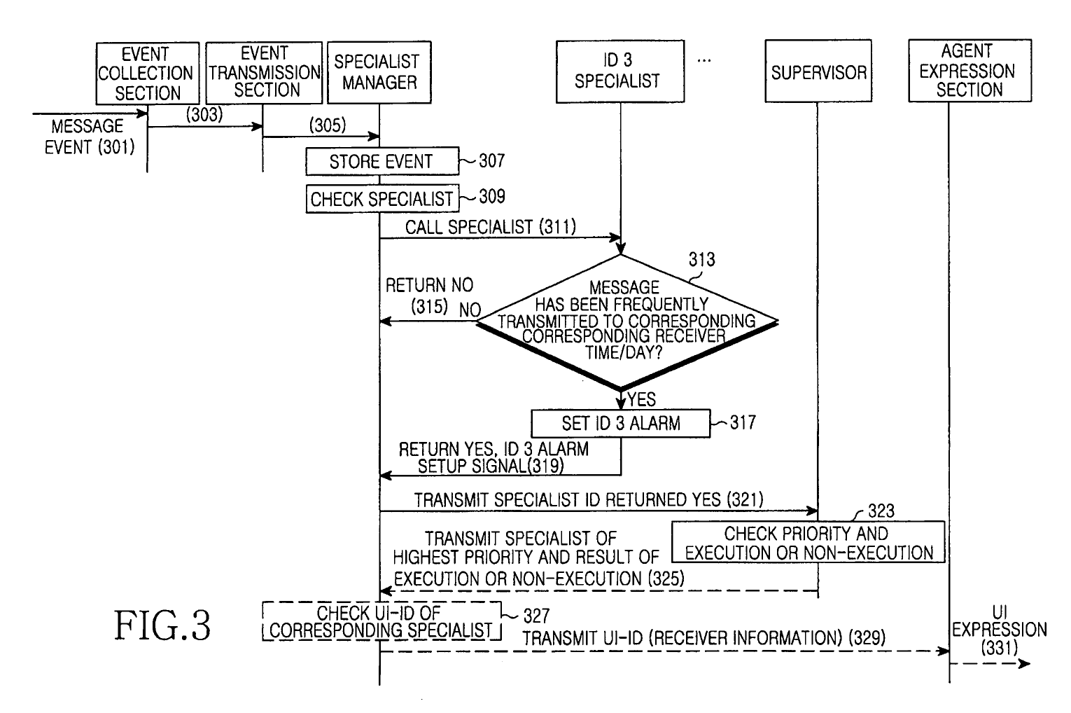

FIG. 3 is a flowchart illustrating an operation for establishing a message communication-recommendation-alarm by a character agent according to an exemplary embodiment of the present invention. Referring to FIG. 3, if a message function-related event occurs at a user's request, the event collection section 110 collects the message function-related event in step 301. Such a message function-related event may include a message function-execution event, a message creation event, a message transmission-completion event, etc. Hereinafter, a case in which a message transmission-completion event occurs after transmitting a message to a receiver (a communication partner) will be described.

The message transmission-completion event is provided to the event transfer section 120 in step 303. In step 305, the event transfer section 120 provides the message transmission-completion event to a specialist manager of the agent control section 130. In step 307, the specialist manager stores the message transmission-completion event in a blackboard. In step 309, the specialist manager checks specialists called in the message transmission-completion event from an internal specialist list. In step 311, the specialist manager calls each specialist (in FIG. 3, a specialist with the ID 3 is called).

If no message transmission occurs after messages have been frequently transmitted at a specific time or on a specific day, the called ID 3 specialist will recommend message transmission within the specific time period in each next predetermined cycle. For example, the specialist recommends message transmission if no message transmission occurs after it has been transmitted more than the predetermined number of times within a specific time period in each predetermined cycle. The specific time period represents the time period from a first predetermined time (e.g. 30 minutes ago) earlier than the time at which a message has been previously transmitted to the receiver, to the current transmission time of the message. The specific time period may also represent the time period from the time, at which a message has been currently transmitted to the receiver, to a second predetermined time (e.g. 30 minutes later) later than the current transmission time of the message, or the time period from the first predetermined time to the second predetermined time.

In step 313, the specialist checks a blackboard and determines if a message has been frequently transmitted to the receiver (communication partner) at a specific time or on a specific day (within the specific time period in each predetermined cycle), e.g. if the message has been transmitted more than three times (threshold number of times). As a result of the determination, when the message has not been transmitted to the receiver more than the threshold number of times within the specific time period in each predetermined cycle, the specialist returns a NO signal to the specialist manager in step 315. However, when the message has been transmitted to the receiver more than the threshold number of times within the specific time period in each predetermined cycle, the specialist sets an ID 3 alarm in step 317 and returns a YES signal and an ID 3 alarm setup signal to the specialist manager in step 319. Herein, the specialist may return information on the receiver (communication partner). For example, in a case in which a user transmits a message to a corresponding receiver (communication partner) at 10:10 PM on Monday of the first week of the month, then transmits a message to the receiver 7 days later at 10:20 PM on Monday of the second week, and retransmits a message to the receiver 7 days later at 10:15 PM on Monday of the third week, this corresponds to a case of transmitting a message more than the predetermined number of times within the specific time period in each predetermined cycle (e.g. 7 days). Accordingly, the specialist sets the ID 3 alarm and returns the ID 3 alarm setup signal to the specialist manager. When setting the ID 3 alarm, the specialist determines an alarm generation time (a predetermined time or the final transmission time of the message within the specific time period in said each next predetermined cycle), and registers the information on the receiver (communication partner) in the ID 3 alarm.

If the signal returned from the called ID 3 specialist is received, the specialist manager provides a supervisor with the ID of the specialist (in FIG. 3, the ID 3 specialist) having returned the YES signal, in step 321. In step 323, the supervisor checks priorities of corresponding specialists. When one specialist has returned a YES signal, the supervisor determines whether the corresponding specialist has been executed. In step 325, the supervisor transmits these results check to a specialist of the highest priority or the corresponding specialist that has been executed to the specialist manager. In step 327, the specialist manager checks the UI-ID of the corresponding specialist of the highest priority or UI-IDs preset according to the IDs of specialists to be executed. In step 329, the specialist manager transmits the checked UI-IDs to the agent expression section 140. In step 331, the agent expression section 140 expresses a corresponding UI. When the specialist manager transmits the UI-IDs to the agent expression section 140, the specialist manager may also transmit information on a corresponding receiver (communication partner).

In the above description, the operation for expressing the setting of the ID 3 alarm by the UI is added. However, the UI expression operation (steps 327, 329 and 331) may be omitted depending on the setting.

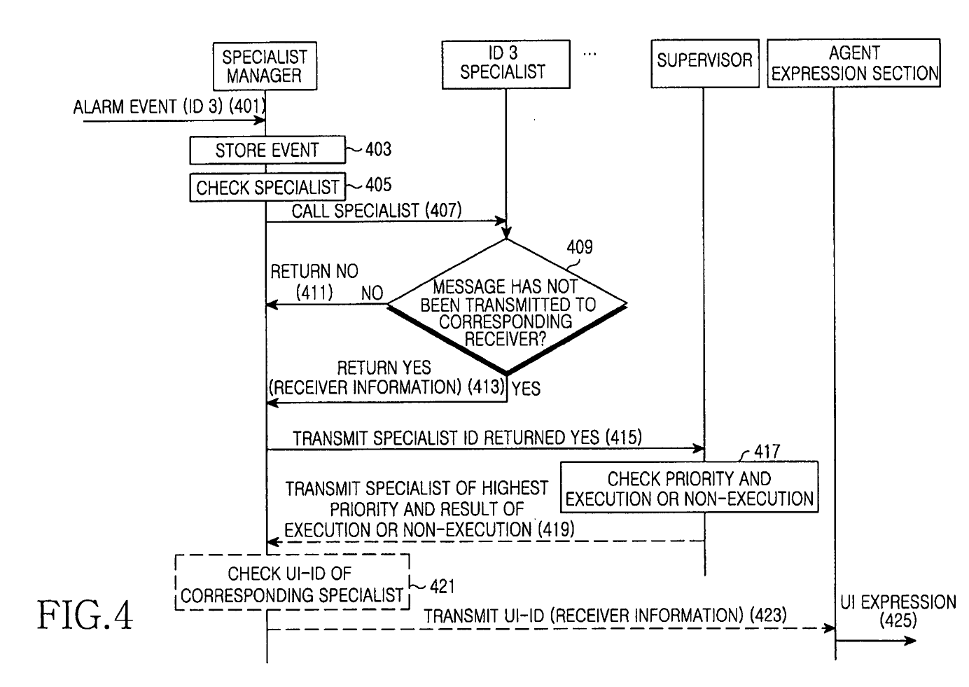

FIG. 4 is a flowchart illustrating an operation for processing a message communication-recommendation-alarm event by the character agent according to one embodiment of the present invention. In the following description, an alarm event provided to a corresponding agent controller may be provided through the event collection section, the event transfer section, etc.

When a message had been frequently transmitted to a predetermined receiver (communication partner) at a specific time or on a specific day and then has not been transmitted, an operation for processing an alarm event for recommending message transmission to the corresponding receiver (communication partner) at a specific time or on a specific day in each next predetermined cycle is described with reference to FIG. 4. If an alarm event of an ID 3 is transferred in step 401, the specialist manager stores the received alarm event in a blackboard in step 403. In step 405, the specialist manager checks specialists called in the alarm event of the ID 3 from an internal specialist list. In step 407, the specialist manager calls each specialist (in FIG. 4, a specialist with the ID 3 is called).

When a message transmitted to a predetermined receiver (communication partner) exceeds the transmission threshold value within a specific time period of each predetermined cycle, the message will not be transmitted. In this case, the called ID 3 specialist recommends message transmission to the receiver (communication partner) within the specific time period in each next predetermined cycle. In step 409, the ID 3 specialist checks a message communication (transmission) history through the blackboard and determines if a message has not been transmitted to the receiver (communication partner) registered in the ID 3 within the specific time period. If the specialist determines that the message has been transmitted to the receiver (communication partner), the ID 3 specialist will return a NO signal to the specialist manager in step 411. Alternatively, when the message has not been transmitted to the receiver (communication partner), the ID 3 specialist returns a YES signal to the specialist manager in step 413. Herein, the ID 3 specialist may return information on the corresponding receiver (communication partner).

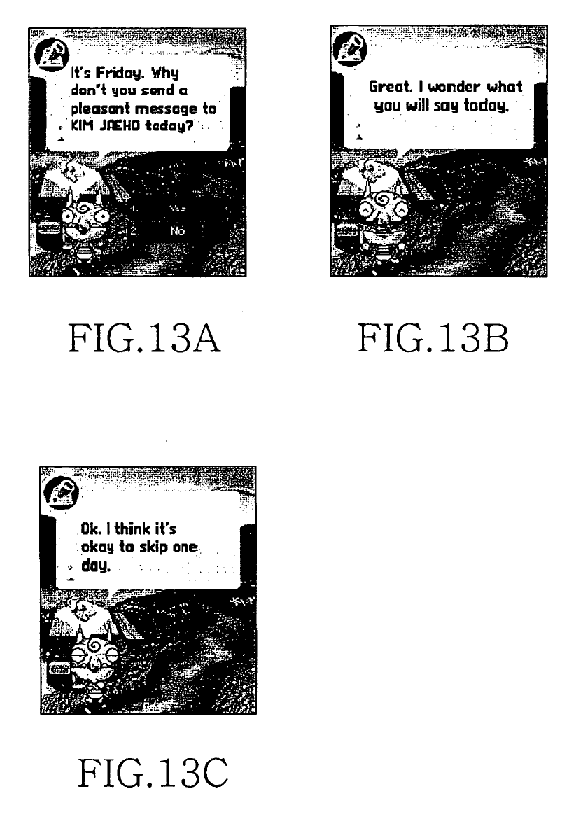

If the signal returned from the called ID 3 specialist is received, the specialist manager provides a supervisor with the ID of the specialist (ID 3 specialist) having returned the YES signal, in step 415. In step 417, the supervisor checks priorities of corresponding specialists and if the corresponding specialists have been executed. In step 419, the supervisor transmits results from the check either for a specialist of the highest priority or regarding whether the corresponding specialists have been executed to the specialist manager. In step 421, the specialist manager checks the UI-ID of the corresponding specialist of the highest priority or the UI-ID of a specialist to be executed. In step 423, the specialist manager transmits the checked UI-ID to the agent expression section 140 for an expression of the corresponding UI. When the agent expression section 140 expresses the corresponding UI in step 425, the agent expression section 140 may output a character, a text and/or a selection button list as illustrated in FIG. 13a in order to allow the UI to include the content for recommending message transmission to the receiver (communication partner). Further, the agent expression section 140 expresses both a smiling character, which approves the message transmission to the receiver, and a text as illustrated in FIG. 13b, or expresses both a sorrowful character, which rejects the message transmission to the receiver, and a text as illustrated in FIG. 13c, according to the feedback action of a user. The expressed character and/or text disappear if a predetermined time passes or a predetermined key is input. Further, if the feedback of rejection occurs, it is possible to initialize the counted cumulative number of times of message transmission, such as to set it to “0”, or it is possible to count backward the predetermined number of times of message transmission. However, if the feedback of approval occurs, it is possible to reset the ID 3 alarm to a date which is N days later. The re-setting of the alarm is for allowing the alarm to be called with a time cycle of N days and to perform a corresponding operation.

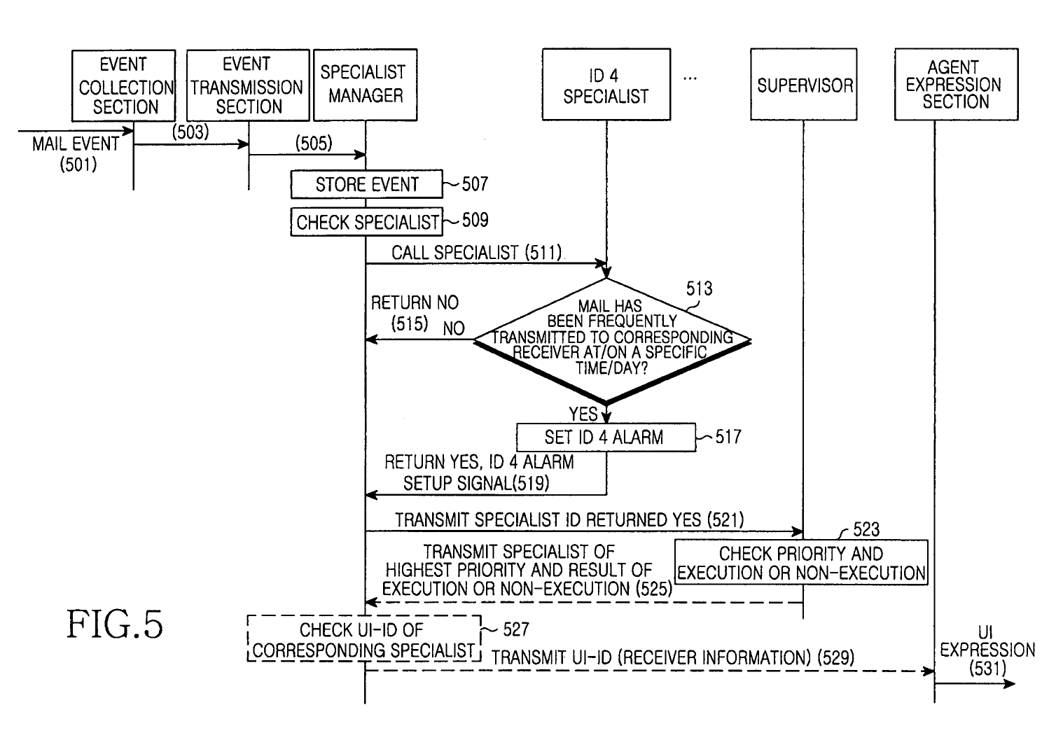

FIG. 5 is a flowchart illustrating an operation for establishing a mail communication-recommendation-alarm by the character agent according to one embodiment of the present invention. Referring to FIG. 5, if a mail function-related event occurs at a user's request, the event collection section 110 collects the mail function-related event in step 301. Such a mail function-related event may be a mail function-execution event, a mail creation event, a mail transmission-completion event, etc. Hereinafter, a case in which a mail transmission-completion event occurs after transmitting mail to a receiver (a communication partner) will be described.

The mail transmission-completion event is provided to the event transmission section 120 in step 503. In step 505, the event transmission section 120 provides the mail transmission-completion event to a specialist manager of the agent control section 130. In step 507, the specialist manager stores the mail transmission-completion event in a blackboard. In step 509, the specialist manager checks specialists called in the mail transmission-completion event from an internal specialist list. In step 511, the specialist manager calls each specialist (in FIG. 5, a specialist with the ID of 4 is called).

If no mail transmission occurs after the mail has been frequently transmitted at a specific time or on a specific day, the called ID 4 specialist will recommend mail transmission within the specific time period in each next predetermined cycle. For example, the specialist recommends mail transmission if no mail transmission occurs after it has been transmitted more than the predetermined number of times within the specific time period in each predetermined cycle. The specific time period represents the time period from a first predetermined time (e.g. 30 minutes ago) earlier than the time at which mail has been previously transmitted to the receiver, to the current transmission time of mail. The specific time period may also represent the time period from the time, at which mail has been currently transmitted to the receiver, to a second predetermined time (e.g. 30 minutes later) later than the current transmission time of mail, or the time period from the first predetermined time to the second predetermined time.

In step 513, the specialist checks a blackboard and determines if mail has been frequently transmitted to the receiver (communication partner) at a specific time or on a specific day (within the specific time period in each predetermined cycle). For example, the specialist checks the blackboard and determines whether mail has been transmitted more than three times (threshold number of times). As a result of the determination, when mail has not been transmitted to the receiver more than the threshold number of times within the specific time period in each predetermined cycle, the specialist returns a NO signal to the specialist manager in step 515. However, when mail has been transmitted to the receiver more than the threshold number of times within the specific time period in each predetermined cycle, the specialist sets an ID 4 alarm in step 517 and returns a YES signal and an ID 4 alarm setup signal to the specialist manager in step 519. Herein, the specialist may return information on the receiver (communication partner). For example, in a case in which a user transmits mail to a corresponding receiver (communication partner) at 12:10 PM on Monday of the first week of the month, then transmits mail to the receiver 7 days later at 12:20 PM on Monday of the second week, and retransmits mail to the receiver 7 days later at 12:15 PM on Monday of the third week, this corresponds to a case of transmitting mail more than the predetermined number of times within the specific time period in each predetermined cycle (e.g. 7 days). Accordingly, the specialist sets the ID 4 alarm and returns the ID 4 alarm setup signal to the specialist manager. When setting the ID 4 alarm, the specialist determines an alarm generation time (a predetermined time or the final transmission time of mail within the specific time period in said each next predetermined cycle), and registers the information on the receiver (communication partner) in the ID 4 alarm.

If the signal returned from the called ID 4 specialist is received, the specialist manager provides a supervisor with the ID of the specialist (in FIG. 5, the ID 4 specialist) having returned the YES signal, in step 521. In step 523, the supervisor checks priorities of corresponding specialists. When one specialist has returned a YES signal, the supervisor determines whether the corresponding specialist has been executed. In step 525, the supervisor transmits these results to a specialist of the highest priority or the corresponding specialist that has been executed to the specialist manager. In step 527, the specialist manager checks the UI-ID of the corresponding specialist of the highest priority or UI-IDs preset according to the IDs of specialists to be executed. In step 529, the specialist manager transmits the checked UI-IDs to the agent expression section 140. In step 531, the agent expression section 140 expresses a corresponding UI. When the specialist manager transmits the UI-IDs to the agent expression section 140, the specialist manager may also transmit information on a corresponding receiver (communication partner).

In the above description, the operation for expressing the setting of the ID 4 alarm by the UI is added. However, the UI expression operation (steps 527, 529 and 531) may be omitted depending on the setting.

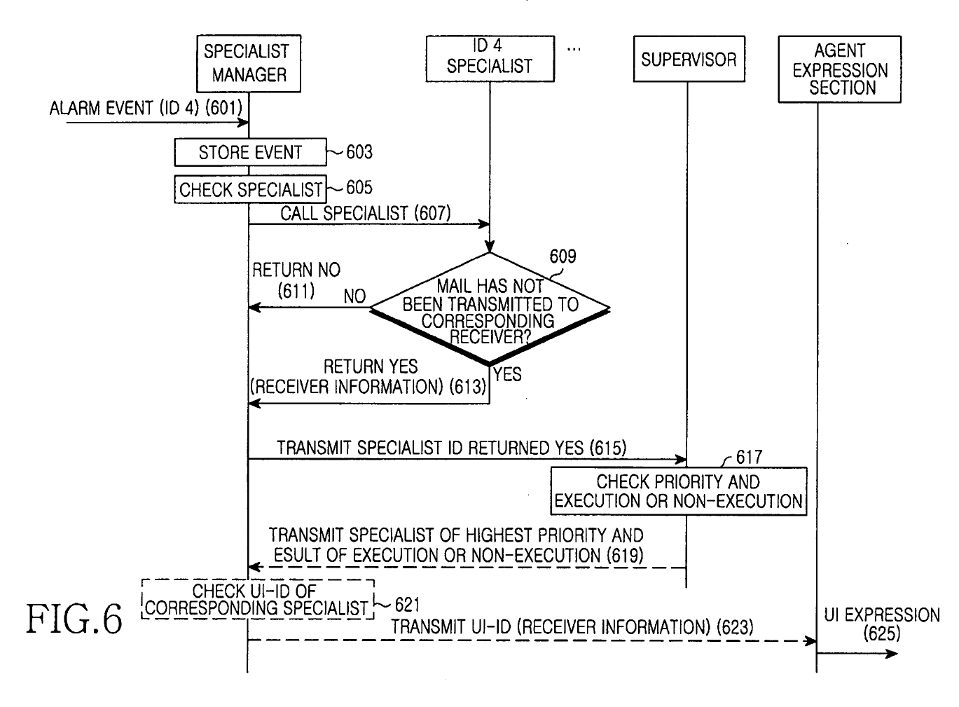

FIG. 6 is a flowchart illustrating an operation for processing a mail communication-recommendation-alarm event by the character agent according to one embodiment of the present invention. In the following description, an alarm event provided to a corresponding agent controller may be provided through the event collection section, the event transfer section, etc.

When mail has been frequently transmitted to a predetermined receiver (communication partner) at a specific time or on a specific day and then has not been transmitted, an operation for processing an alarm event for recommending mail transmission to the corresponding receiver (communication partner) at a specific time or on a specific day in each next predetermined cycle is described with reference to FIG. 6. If an alarm event of an ID 4 is transferred in step 601, the specialist manager stores the received alarm event in a blackboard in step 603. In step 605, the specialist manager checks specialists called in the alarm event of the ID 4 from an internal specialist list. In step 407, the specialist manager calls each specialist (in FIG. 6, a specialist with the ID of 4 is called).

When mail has been transmitted to a predetermined receiver (communication partner) more than the threshold number of times within the specific time period in each predetermined cycle, and then is not transmitted, the called ID 4 specialist will recommend mail transmission to the receiver (communication partner) within the specific time period in each next predetermined cycle. In step 609, the ID 4 specialist checks a mail communication (transmission) history through the blackboard and determines if mail has not been transmitted to the receiver (communication partner) registered in the ID 4 within the specific time period. If the specialist determines that the mail has been transmitted to the receiver (communication partner), the ID 4 specialist returns a NO signal to the specialist manager in step 611. Alternatively, when mail has not been transmitted to the receiver (communication partner), the ID 4 specialist returns a YES signal to the specialist manager in step 613. Herein, the ID 4 specialist may return information on the corresponding receiver (communication partner).

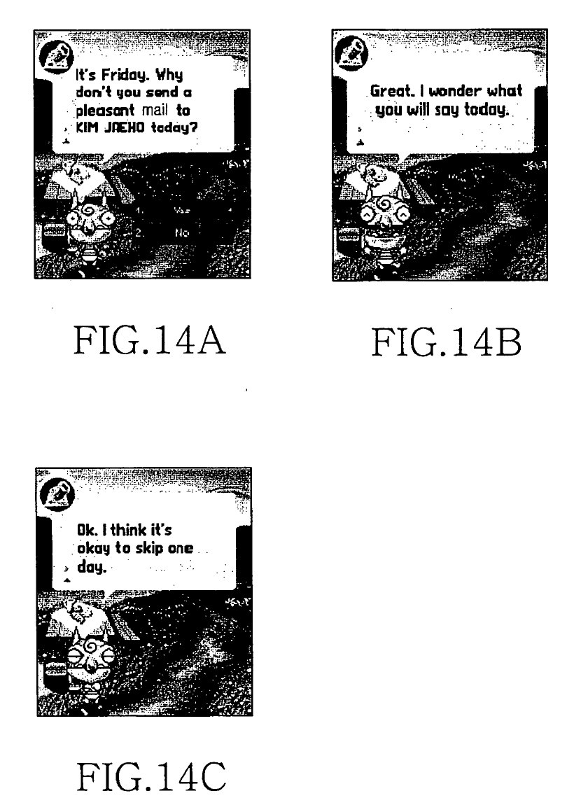

If the signal returned from the called ID 4 specialist is received, the specialist manager provides a supervisor with the ID of the specialist (ID 4 specialist) having returned the YES signal, in step 615. In step 617, the supervisor checks priorities of corresponding specialists and if the corresponding specialists have been executed. In step 619, the supervisor transmits results from the check either for a specialist of the highest priority or regarding whether the corresponding specialists have been executed to the specialist manager. In step 621, the specialist manager checks the UI-ID of the corresponding specialist of the highest priority or the UI-ID of a specialist to be executed. In step 623, the specialist manager transmits the checked UI-ID to the agent expression section 140 for an expression of the corresponding UI. When the agent expression section 140 expresses the corresponding UI in step 625, the agent expression section 140 may output a character, a text and/or a selection button list as illustrated in FIG. 14a in order to allow the UI to include the content for recommending mail transmission to the receiver (communication partner). Further, the agent expression section 140 expresses both a smiling character, which approves the mail transmission to the receiver, and a text as illustrated in FIG. 14b, or expresses both a sorrowful character, which rejects the mail transmission to the receiver, and a text as illustrated in FIG. 14c, according to the feedback action of a user. The expressed character and/or text disappear if a predetermined time passes or a predetermined key is input. Further, if the feedback of rejection occurs, it is possible to initialize the accumulated and counted number of times of mail transmission, such as to set it to “0”, or it is possible to minus-count the predetermined number of times of message transmission. However, if the feedback of approval occurs, it is possible to reset the ID 4 alarm to a date which is N days later. The re-setting of the alarm is for allowing the alarm to be called with a time cycle of N days and to perform a corresponding operation.

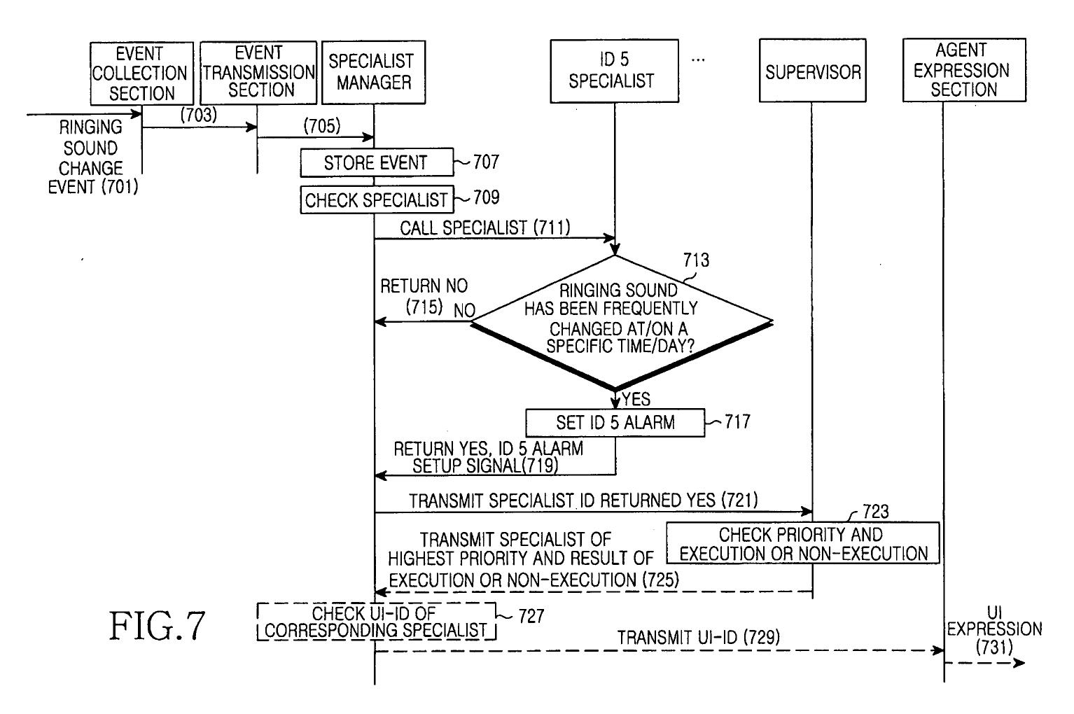

FIG. 7 is a flowchart illustrating an operation for establishing a ringing sound change-recommendation-alarm by the character agent according to one embodiment of the present invention. Referring to FIG. 7, if a ringing sound change event occurs at a user's request, the event collection section 110 collects the ringing sound change event in step 701. The ringing sound change is provided to the event transfer section 120 in step 703. In step 705, the event transfer section 120 provides the ringing sound change event to a specialist manager of the agent control section 130. In step 707, the specialist manager stores the ringing sound change event in a blackboard. In step 709, the specialist manager checks specialists called in the ringing sound change event from an internal specialist list. In step 711, the specialist manager calls each specialist (in FIG. 7, a specialist with the ID of 5 is called).

If no change in the ringing sound occurs after it has been frequently changed at a specific time or on a specific day, the called ID 5 specialist recommends a change in the ringing sound within the specific time period in each next predetermined cycle. For example, the specialist recommends a change in the ringing sound if no change in the ringing sound occurs after it has been changed more than the predetermined number of times within a specific time period in each predetermined cycle. The specific time period represents the time period from a first predetermined time (e.g. 30 minutes ago) earlier than the time at which the ringing sound has been previously changed, to the time at which the ringing sound has been currently changed. The specific time period may also represent the time period from the time, at which ringing sound has been currently changed, to a second predetermined time (e.g. 30 minutes later) later than the time at which the ringing sound has been currently changed, or the time period from the first predetermined time to the second predetermined time.

In step 713, the specialist checks a blackboard and determines if the ringing sound has been frequently changed at a specific time or on a specific day (within the specific time period in each predetermined cycle), e.g. if the ringing sound has been changed more than three times (threshold number of times). As a result of the determination, when the ringing sound has not been changed more than the threshold number of times within the specific time period in each predetermined cycle, the specialist returns a NO signal to the specialist manager in step 715. However, when the ringing sound has been frequently changed more than the threshold number of times within the specific time period in each predetermined cycle, the specialist sets an ID 5 alarm in step 717 and returns a YES signal and an ID 5 alarm setup signal to the specialist manager in step 719. Herein, the specialist may return information on the ringing sound. For example, in a case in which a user changes ringing sound at 10:10 PM on Monday of the first week of the month, then changes the ringing sound 7 days later at 10:20 PM on Monday of the second week, and changes again the ringing sound 7 days later at 10:15 PM on Monday of the third week, this corresponds to a case of changing the ringing sound more than the predetermined number of times within the specific time period in each predetermined cycle (e.g. 7 days). Accordingly, the specialist sets the ID 5 alarm and returns the ID 5 alarm setup signal to the specialist manager. When setting the ID 5 alarm, the specialist determines an alarm generation time (a predetermined time or the final change time of the ringing sound within the specific time period in said each next predetermined cycle). Further, the specialist registers information on specific ringing sound in the ID 5 alarm, so that it is possible to recommend the change to the registered ringing sound in the ID 5 alarm.

If the signal returned from the called ID 5 specialist is received, the specialist manager provides a supervisor with the ID of the specialist (in FIG. 7, the ID 5 specialist) having returned the YES signal, in step 721. In step 723, the supervisor checks priorities of corresponding specialists. When one specialist has returned a YES signal, the supervisor determines whether the corresponding specialist has been executed. In step 725, the supervisor transmits these results to a specialist of the highest priority or the corresponding specialist that has been executed to the specialist manager. In step 727, the specialist manager checks the UI-ID of the corresponding specialist of the highest priority or UI-IDs preset according to the IDs of specialists to be executed. In step 729, the specialist manager transmits the checked UI-IDs to the agent expression section 140. In step 731, the agent expression section 140 expresses a corresponding UI. When the specialist manager transmits the UI-IDs to the agent expression section 140, the specialist manager may also transmit the information on the specific ringing sound.

In the above description, the operation for expressing the setting of the ID 5 alarm by the UI is added. However, the UI expression operation (steps 727, 729 and 731) may be omitted depending on the setting.

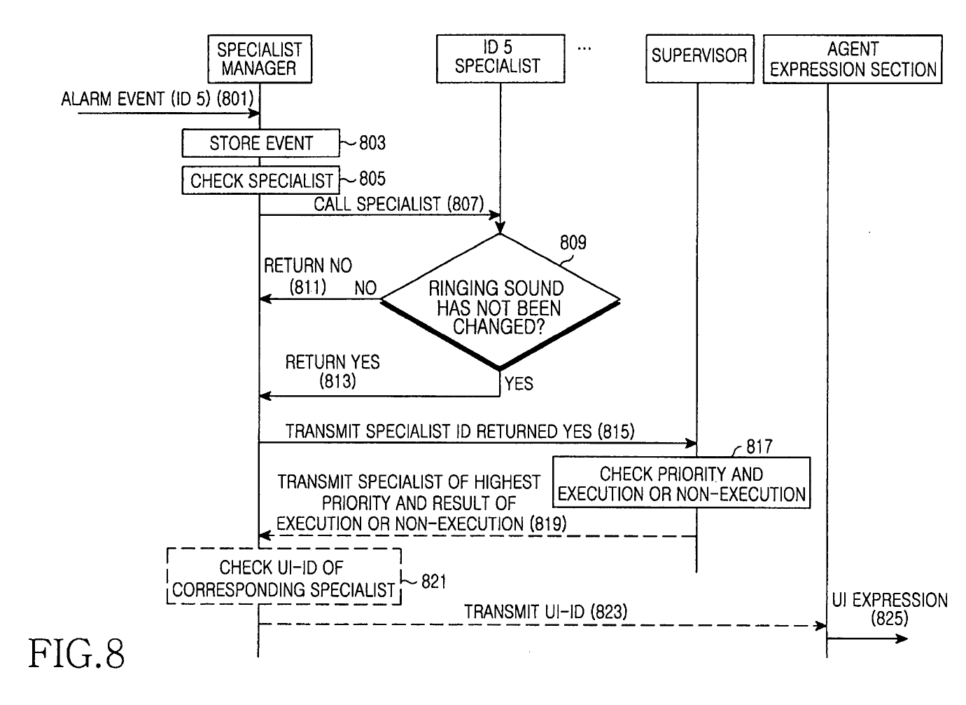

FIG. 8 is a flowchart illustrating an operation for processing a ringing sound change-recommendation-alarm event by the character agent according to one embodiment of the present invention. In the following description, an alarm event provided to a corresponding agent controller may be provided through the event collection section, the event transfer section, etc.

When the ringing sound has been frequently changed at a specific time or on a specific day in each predetermined cycle and then has not been changed, an operation for processing an alarm event for recommending the change of ringing sound at a specific time or on a specific day in each next predetermined cycle is described with reference to FIG. 8. If an alarm event of an ID 5 is transferred in step 801, the specialist manager stores the received alarm event in a blackboard in step 803. In step 805, the specialist manager checks specialists called in the alarm event of the ID 5 from an internal specialist list. In step 807, the specialist manager calls each specialist (in FIG. 8, a specialist with the ID of 5 is called).

When the ringing sound has been changed more than the threshold number of times within the specific time period in each predetermined cycle and then is not changed, the called ID 5 specialist recommends the change of ringing sound within the specific time period in each next predetermined cycle. In step 809, the ID 5 specialist checks a ringing sound change history through the blackboard and determines if the ringing sound has not been changed during the specific time period or the ringing sound has not been changed to the ringing sound registered in the ID 5. As a result of the determination, when the ringing sound has been changed, the ID 5 specialist returns a NO signal to the specialist manager in step 811. However, when the ringing sound has not been changed, the ID 5 specialist returns a YES signal to the specialist manager in step 813. Herein, the ID 5 specialist may also return information on the corresponding ringing sound.

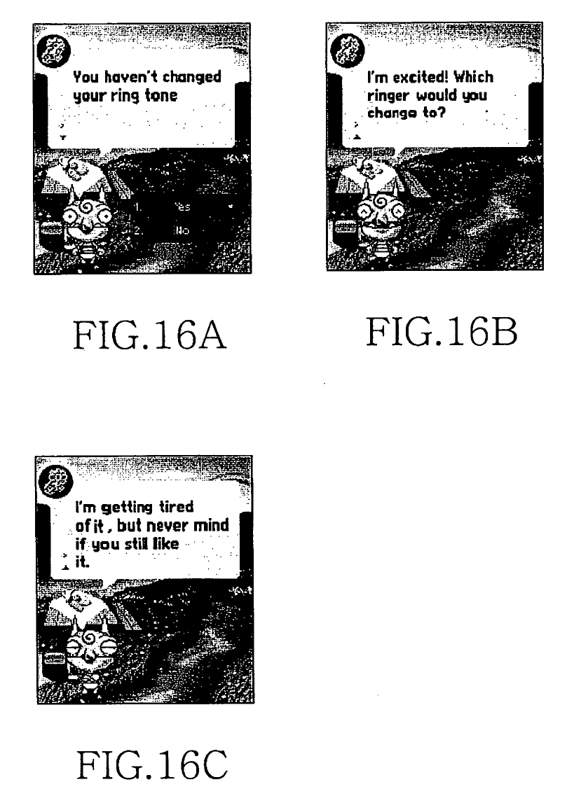

If the signal returned from the called ID 5 specialist is received, the specialist manager provides a supervisor with the ID of the specialist (ID 5 specialist) having returned the YES signal, in step 815. In step 817, the supervisor checks priorities of corresponding specialists and if the corresponding specialists have been executed. In step 819, the supervisor transmits results from the check either for a specialist of the highest priority or regarding whether the corresponding specialists have been executed to the specialist manager. In step 821, the specialist manager checks the UI-ID of the corresponding specialist of the highest priority or the UI-ID of a specialist to be executed. In step 823, the specialist manager transmits the checked UI-ID to the agent expression section 140 for an expression of the corresponding UI. When the agent expression section 140 expresses the corresponding UI in step 825, the agent expression section 140 may output a character, a text and/or a selection button list as illustrated in FIG. 16a in order to allow the UI to include the content for recommending the change of ringing sound. Further, the agent expression section 140 expresses both a smiling character, which approves the change of ringing sound, and a text as illustrated in FIG. 16b, or expresses both a sorrowful character, which rejects the change of ringing sound, and a text as illustrated in FIG. 16c, according to the feedback action of a user. The expressed character and/or text disappear if a predetermined time passes or a predetermined key is input. Further, if the feedback of rejection occurs, it is possible to initialize the accumulated and counted number of times of mail transmission, such as to set it to “0”, or it is possible to minus-count the predetermined number of times of message transmission. However, if the feedback of approval occurs, it is possible to reset the ID 5 alarm to a date which is N days later. Re-setting the alarm allows the alarm to be called with a time cycle of N days and to perform a corresponding operation.

As described above, each specialist of the character agent can perform operations for processing the functions (the message event, the mail event, the ringing sound event, etc.) frequently used at a specific time or on a specific day. Hereinafter, an entire operation according to the processing of the function event of the wireless terminal, which is frequently used at a specific time or on a specific day, will be described with reference to the accompanying drawings. Further, the controller 100 with no divided function blocks controls a single agent system, and controls the memory 23 and the display unit 27, thereby realizing the present invention. The memory 23 may store function events occurring in the wireless terminal.

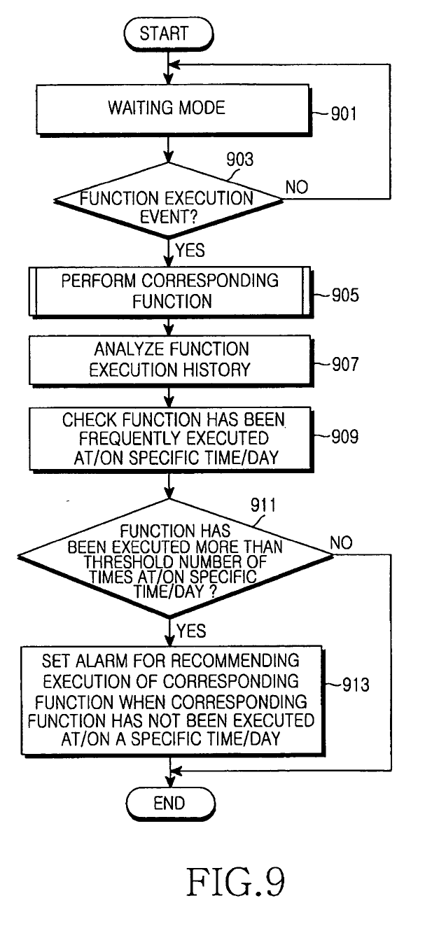

FIG. 9 is a flowchart illustrating an operation for establishing a function execution-recommendation alarm of the wireless terminal according to one embodiment of the present invention. When the function of the wireless terminal had been frequently executed at a specific time or on a specific day and then has not been executed, an operation for establishing an alarm for recommending the execution of a corresponding function at a specific time or on a specific day in each next predetermined cycle is described with reference to FIG. 9. If a function execution event of the wireless terminal occurs in a waiting mode in step 901, the controller 100 detects the occurrence of the function execution event in step 903. In step 905, the controller 100 controls the memory 23 and the display unit 27, thereby performing the corresponding function of the wireless terminal. The function of the wireless terminal may include a phone communication function, a message function, a mail function, an application program function, a ringing sound change function, a morning call registration function, etc. The function execution event in the wireless terminal may occur through the use of a menu, a hot key, etc.

In step 905, the controller 100 controls the memory 23 to store function execution information applied and occurring when the corresponding function of the wireless terminal is executed. For example, if a phone communication function is selected at a user's request, the controller 100 executes the phone communication function, and stores phone communication function-execution information which is applied and occurring when the phone communication function is executed. If a ringing sound change function is selected at a user's request, the controller 100 executes the ringing sound change function, and stores ringing sound change function-execution information which is applied and occurring when the ringing sound change function is executed. The function execution information includes time information, day information and date information, which relate to the execution of a corresponding function, type information of a function, and/or supplementary information (receiver information, ringing sound information) applied to the execution of a function.

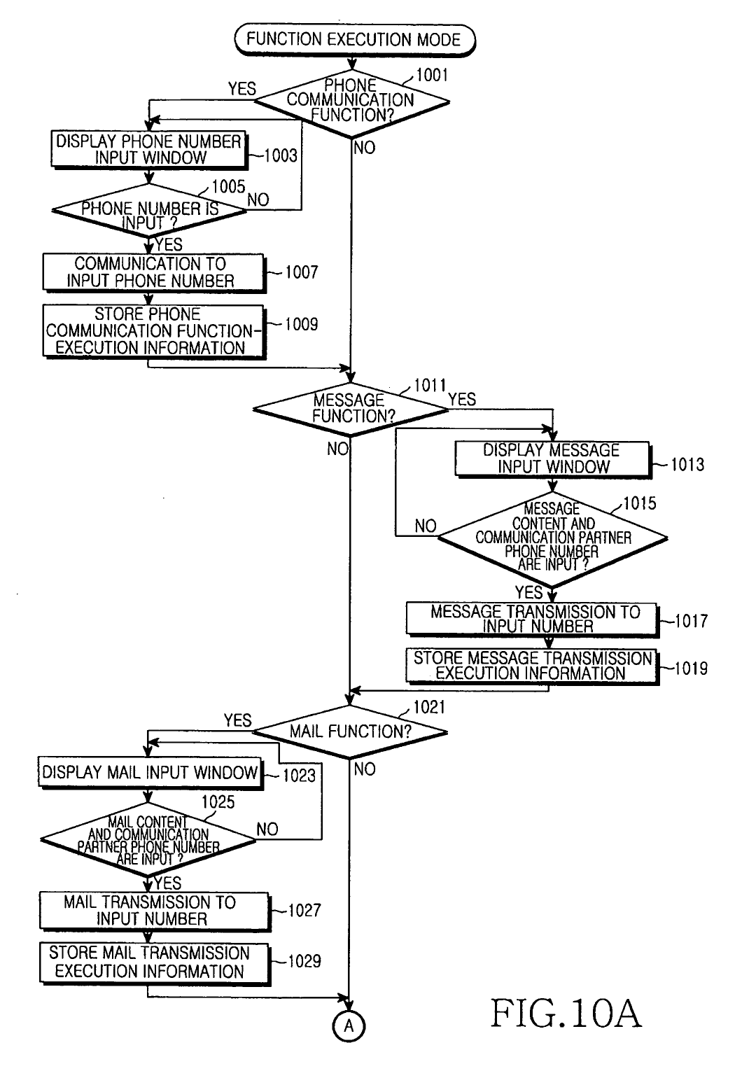

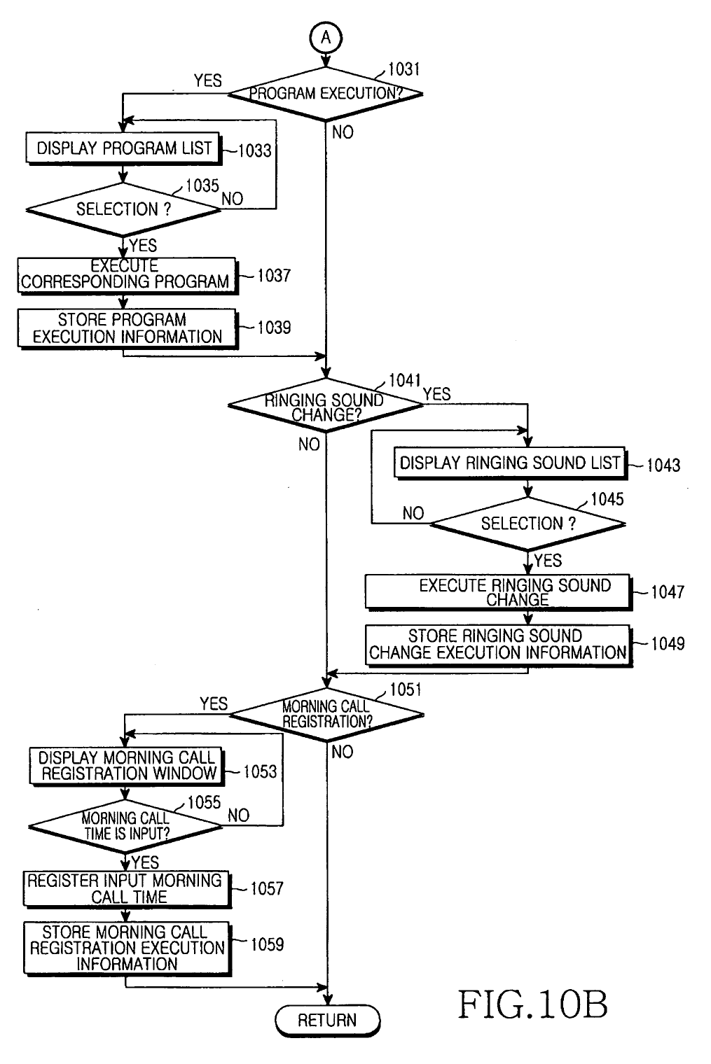

An operation for executing the corresponding function of the wireless terminal, and storing the function execution information applied to and occurs in the execution of the function is described in detail with reference to FIGS. 10a and 10b.

In step 907, the controller 100 analyzes a function execution history which has recorded the function execution information of the function executed up to the current time point. The function execution history may classify executed functions of the wireless terminal and store function execution information applied to and occurs in the execution of a corresponding function.

In step 909, the controller 100 determines if a currently executed function of the wireless terminal has been frequently executed at a specific time or on a specific day. This corresponds to a case in which the function of the wireless terminal has been executed more than the predetermined number of times within the specific time period in each predetermined cycle. For example, a case in which a wireless terminal user executes a predetermined function of the wireless terminal at 10:10 AM on Monday of the first week of the month, then executes the same function of the wireless terminal 7 days later at 10:20 AM on Monday of the second week, and executes again the corresponding function of the wireless terminal 7 days later at 10:15 AM on Monday of the third week, this case may correspond to a case in which the function of the wireless terminal has been executed more than the predetermined number of times within the specific time period in each predetermined cycle (7 days). The specific time period represents the time period from a first predetermined time (e.g. 30 minutes ago) earlier than the final execution time of the function of the wireless terminal to the execution time of the function of the wireless terminal. The specific time period may also represent the time period from the final execution time of the function of the wireless terminal to a second predetermined time (e.g. 30 minutes later) later than the execution time of the function of the wireless terminal, or the time period from the first predetermined time to the second predetermined time.

As a result of the determination, when the corresponding function of the wireless terminal has not been frequently (more than the threshold number of times) executed at a specific time or on a specific day, the operation procedure ends. However, when the corresponding function of the wireless terminal has been frequently executed at a specific time or on a specific day, step 913 is performed. That is, the controller 100 sets an alarm for recommending the execution of the corresponding function of the wireless terminal when the corresponding function of the wireless terminal has not been executed at a specific time or on a specific day. When setting the alarm, the controller 100 determines an alarm generation time (either a predetermined time or the final execution time of the function of the wireless terminal within the specific time period in said each next predetermined cycle), and registers supplementary information applied to the set alarm.

FIGS. 10a and 10b are flowchart illustrating an operation for executing the functions applied to FIG. 9. An operation for executing the corresponding function of the wireless terminal occurred in step 905 of FIG. 9 and storing the function execution information applied and occurring when the corresponding function is executed is described in detail with reference to FIGS. 10a and 10b. First, if a phone communication function event occurs at a user's request, the controller 100 detects the occurrence of the phone communication function event in step 1001. In step 1003, the controller 100 controls the memory 23 and the display unit 27, thereby displaying an input window used for input of the receiver information (communication partner phone number). If a user inputs the receiver information (communication partner phone number) by means of the key input unit 25, the controller 100 detects the input of the receiver information and displays the input receiver information in step 1005. If a communication key is input, the controller 100 attempts a communication connection to the input receiver information (communication partner phone number), and performs the phone communication in step 1007. In step 1009, the controller 100 controls the memory 23 to store the phone communication function-execution information which is applied to and occurs in the execution of the phone communication function. The phone communication function-execution information includes time information, day information and date information, which relate to the execution of the phone communication function, type information of an executed function, information on a communication partner corresponding to a called party, and information on the number of phone communication connections to the communication partner.

Second, if a message function event occurs at a user's request, the controller 100 detects the occurrence of the message function event in step 1011. In step 1013, the controller 100 controls the memory 23 and the display unit 27, thereby displaying a message input window used for input of both a message content and receiver information (communication partner phone number). If a user inputs the message content and the receiver information (communication partner phone number) by means of the key input unit 25, the controller 100 detects the input of the message content and the receiver information and displays the message content and the receiver information in step 1015. If a transmission key is input, the controller 100 transmits the input message to the input receiver information (communication partner phone number) in step 1017. In step 1019, the controller 100 controls the memory 23 to store message function-execution information which is applied and occurs in the execution of the message function. The message function-execution information includes time information, day information and date information, which relate to the execution of the message function, type information of an executed function, information on a communication partner to which a message has been transmitted, and information on the number of times by which a message has been transmitted to the communication partner.

Third, if a mail function event occurs at a user's request, the controller 100 detects the occurrence of the mail function event in step 1021. In step 1023, the controller 100 controls the memory 23 and the display unit 27, thereby displaying a mail input window used for input of both a mail content and receiver information (communication partner phone number). If a user inputs the mail content and the receiver information (communication partner phone number) by means of the key input unit 25, the controller 100 detects the input of the mail content and the receiver information and displays the mail content and the receiver information in step 1025. If a transmission key is input, the controller 100 transmits the input mail to the input receiver information (communication partner phone number) in step 1027. In step 1029, the controller 100 controls the memory 23 to store mail function-execution information which is applied and occurs in the execution of the mail function. The mail function-execution information includes time information, day information and date information, which relate to the execution of the mail function, type information of an executed function, information on a communication partner to which mail has been transmitted, and information on the number of times by which mail has been transmitted to the communication partner.

Fourth, if an application program function event occurs at a user's request, the controller 100 detects the occurrence of the application program function event in step 1031. In step 1033, the controller 100 controls the memory 23 and the display unit 27, thereby displaying an application program execution list. The application program execution list includes programs having a game function, a schedule management function, an image photographing function, etc. If a user selects a corresponding application program from the displayed application program execution list by means of the key input unit 25, the controller 100 detects the selection of the corresponding application program in step 1035 and executes the selected application program in step 1037. In step 1039, the controller 100 controls the memory 23 to store function-execution information of the application program occurring in the execution of the corresponding application program. The function-execution information of the application program includes time information, day information and date information, which relate to the execution of the corresponding application program, type information of an executed application program, and information on the number of times by which an application program has been executed.

Fifth, if a ringing sound change-function event occurs at a user's request, the controller 100 detects the occurrence of the ringing sound change-function event in step 1041. In step 1043, the controller 100 controls the memory 23 and the display unit 27, thereby displaying a ringing sound list. If a user selects a corresponding ringing sound from the displayed ringing sound list by means of the key input unit 25, the controller 100 detects the selection of the ringing sound in step 1045 and performs a change to the selected ringing sound in step 1047. In step 1049, the controller 100 controls the memory 23 to store function-execution information of ringing sound occurring in the change of the corresponding ringing sound. The function-execution information of the ringing sound includes time information, day information and date information, which relate to the change of the corresponding ringing sound, type information of changed ringing sound, and information on the number of times by which the corresponding ringing sound has been changed.

Last, if a morning call registration event occurs at a user's request, the controller 100 detects the occurrence of the application program function event in step 1051. In step 1053, the controller 100 controls the memory 23 and the display unit 27, thereby displaying a morning call registration window used for input of a morning call time. If a user inputs the morning call time by means of the key input unit 25, the controller 100 detects the input of the morning call time in step 1055. If a registration key is input, the controller 100 controls the memory 23 and registers the input morning call time in step 1057. In step 1059, the controller 100 controls the memory 23 to store morning call registration function-execution information occurring in the execution of the morning call registration function. The morning call registration function-execution information includes time information, day information and date information, which relate to the execution of the morning call function, type information of an executed function, and information on the number of times by which the morning call function has been executed.

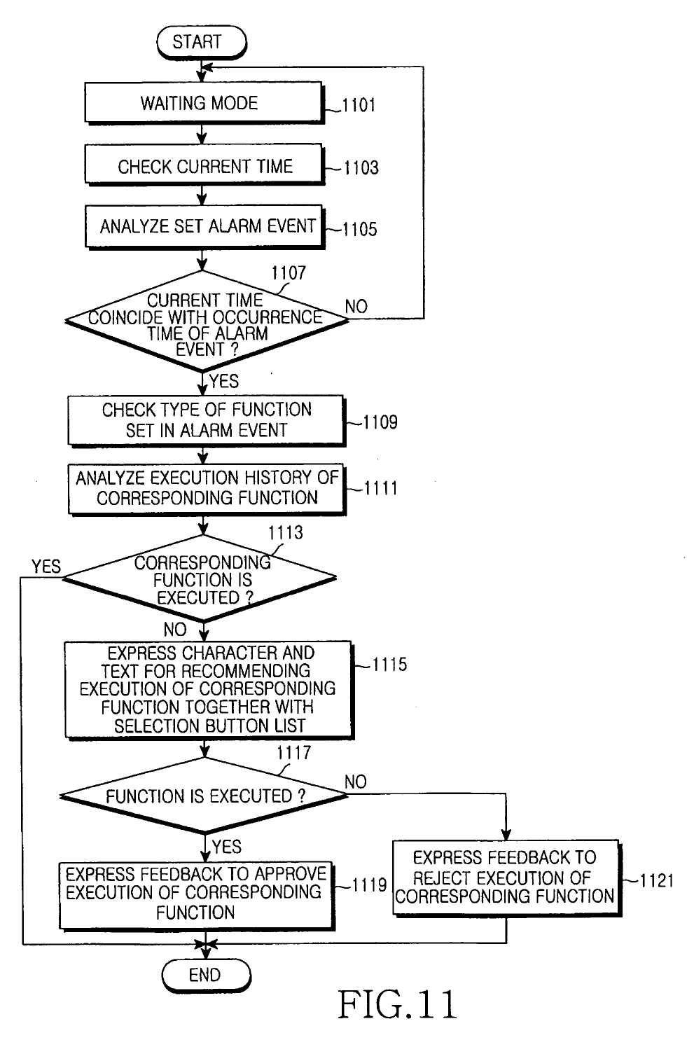

FIG. 11 is a flowchart illustrating an operation for processing a function execution-recommendation alarm event of the wireless terminal according to one embodiment of the present invention. When the function of the wireless terminal has been frequently executed at a specific time or on a specific day and then has not been executed, an operation for processing an alarm event for recommending the execution of a corresponding function at a specific time or on a specific day in each next predetermined cycle is described with reference to FIG. 11. The wireless terminal is in a waiting mode in step 1101. In step 1103, the controller 100 checks the current time. In step 1105, the controller 100 analyzes a set alarm event (when the function of the wireless terminal continuously executed at a specific time or on a specific day has not been executed, an alarm for recommending the execution of the corresponding function of the wireless terminal), and checks an occurrence time of the set alarm event. The occurrence time of the alarm event represents the set time of occurrence of the alarm event, such as either a predetermined time or the final execution time of the corresponding function of the wireless terminal within the specific time period in each next predetermined cycle.

If the current time coincides with the occurrence time of the set alarm event, the controller 100 detects the coincidence fact in step 1107. In step 1109, the controller 100 controls the memory 23 and checks the type of a function having been set in the alarm event. The function having been set in the alarm event may include a phone communication function, a message function, a mail function, an application program function, a ringing sound change function, a morning call registration function, etc.

In step 1111, the controller 100 controls the memory 23 and analyzes an execution history of the checked function, thereby determining if a corresponding function has been executed within the specific time period. The specific time period may include the time period from a first predetermined time (e.g. 30 minutes ago) earlier than the final execution time of the function of the wireless terminal to the execution time of the function of the wireless terminal. The specific time period may also include the time period from the final execution time of the function of the wireless terminal to a second predetermined time (e.g. 30 minutes later) later than the execution time of the function of the wireless terminal, or the time period from the first predetermined time to the second predetermined time.

As a result of the determination, if the corresponding function registered in the alarm event has been executed within the specific time period, the controller 100 detects the execution of the corresponding function in step 1113, and terminates the operation procedure. However, if the corresponding function registered in the alarm event has not been executed within the specific time period, the controller 100 detects the non-execution of the corresponding function in step 1113, and expresses a character and a text for recommending the execution of the corresponding function together with the selection button list in step 1115. Herein, corresponding function execution information may be applied to the recommendation expression. The function execution history includes time information, day information and date information, which relate to the execution of the corresponding function, type information of a function, and/or supplementary information (receiver information, ringing sound information) applied to the execution of a function.

Then, if a user selects an approval from the selection button list, the controller 100 detects the selection of the approval in step 1117, and expresses feedback to approve the execution of the corresponding function in step 1119. However, if a user selects a rejection from the selection button list, the controller 100 detects the selection of the rejection in step 1117, and expresses feedback to reject the execution of the corresponding function in step 1121.

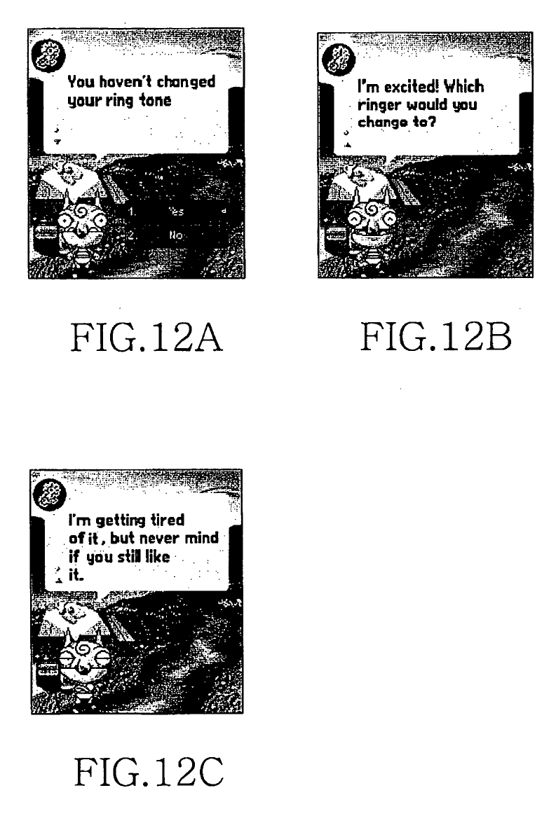

For example, first, if a function set in the occurred alarm event corresponds to a phone communication function, the controller 100 expresses a character and a text for recommending the execution of the phone communication function together with the selection button list as illustrated in FIG. 12a. Then, if a user selects YES (first item) from the selection button list, the controller 100 expresses feedback to approve the execution of the phone communication function symbolized by a smiling character and text representing the approval of the execution of the phone communication function as illustrated in FIG. 12b. However, if a user selects NO (second item) from the selection button list, the controller 100 expresses feedback to reject the execution of the phone communication function symbolized by a sorrowful character and text representing the rejection of the execution of the phone communication function as illustrated in FIG. 12c.

Second, if a function set in the occurred alarm event corresponds to a message function, the controller 100 expresses a character and text for recommending the execution of the message function together with the selection button list as illustrated in FIG. 13a. Then, if a user selects YES (first item) from the selection button list, the controller 100 expresses feedback to approve the execution of the message function symbolized by a smiling character and text representing the approval of the execution of the message function as illustrated in FIG. 13b. However, if a user selects NO (second item) from the selection button list, the controller 100 expresses feedback to reject the execution of the message function symbolized by a sorrowful character and text representing the rejection of the execution of the message function as illustrated in FIG. 13c.

Third, if a function set in the occurred alarm event corresponds to a mail function, the controller 100 expresses a character and text for recommending the execution of the mail function together with the selection button list as illustrated in FIG. 14a. Then, if a user selects YES (first item) from the selection button list, the controller 100 expresses feedback to approve the execution of the mail function symbolized by a smiling character and text representing the approval of the execution of the mail function as illustrated in FIG. 14b. However, if a user selects NO (second item) from the selection button list, the controller 100 expresses feedback to reject the execution of the mail function symbolized by a sorrowful character and text representing the rejection of the execution of the mail function as illustrated in FIG. 14c.

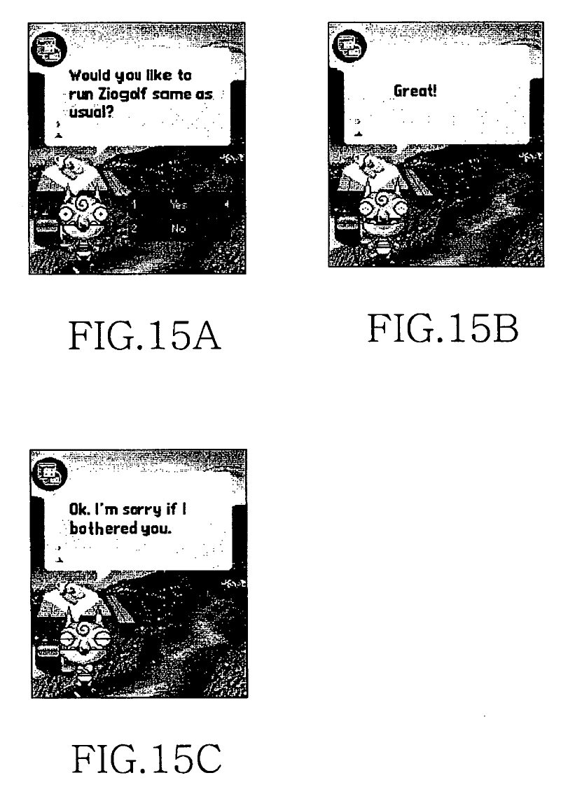

Fourth, if a function set in the occurred alarm event corresponds to an application program function, the controller 100 expresses a character and text for recommending the execution of the application program function together with the selection button list as illustrated in FIG. 15a. Then, if a user selects YES (first item) from the selection button list, the controller 100 expresses feedback to approve the execution of the application program function symbolized by a smiling character and text representing the approval of the execution of the application program function as illustrated in FIG. 15b. However, if a user selects NO (second item) from the selection button list, the controller 100 expresses feedback to reject the execution of the application program function symbolized by a sorrowful character and text representing the rejection of the execution of the application program function as illustrated in FIG. 15c.

Fifth, if a function set in the occurred alarm event corresponds to a ringing sound change function, the controller 100 expresses a character and text for recommending ringing sound change together with the selection button list as illustrated in FIG. 16a. Then, if a user selects YES (first item) from the selection button list, the controller 100 expresses feedback to approve the ringing sound change symbolized by a smiling character and text representing the approval of the ringing sound change as illustrated in FIG. 16b. However, if a user selects NO (second item) from the selection button list, the controller 100 expresses feedback to reject the ringing sound change symbolized by a sorrowful character and text representing the rejection of the ringing sound change as illustrated in FIG. 16c.

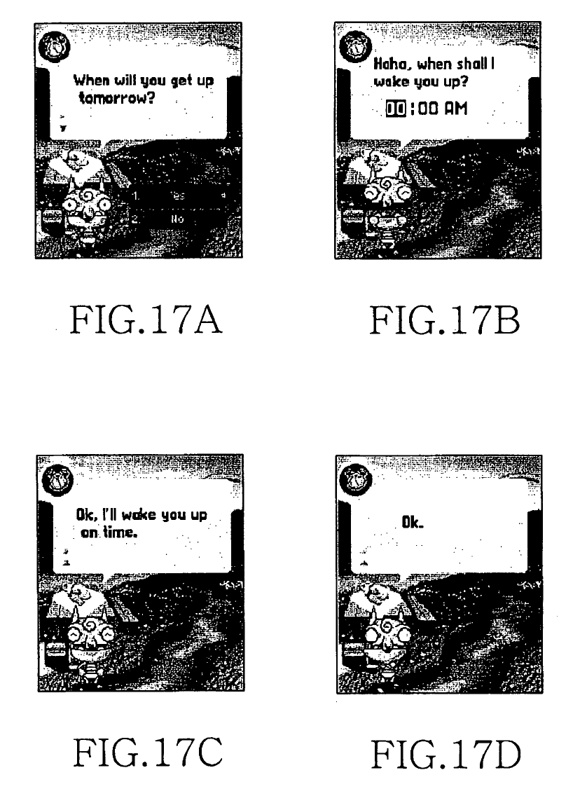

Last, if a function set in the occurred alarm event corresponds to a morning call registration function, the controller 100 expresses a character and text for recommending morning call registration together with the selection button list as illustrated in FIG. 17a. Then, if a user selects YES (first item) from the selection button list, the controller 100 expresses a smiling character, and an image and text used in order to set a morning call time as illustrated in FIG. 17b. If the morning call time is set, the controller 100 expresses feedback to approve the morning call registration symbolized by a smiling character and text representing the approval of the morning call registration as illustrated in FIG. 17c. However, if a user selects NO (second item) from the selection button list, the controller 100 expresses feedback to reject the morning call registration symbolized by a sorrowful character and text representing the rejection of the morning call registration as illustrated in FIG. 17d. Further, the expressed character and/or text disappear if a predetermined time passes or a predetermined key is input.

According to embodiments of the present invention as described above, a character agent function can be added to a wireless terminal. When a predetermined function has been executed at a specific time or on a specific day more than the predetermined number of times, the function is determined as a function frequently used at a specific time or on a specific day. Accordingly, when a user has not executed the function at a specific time or on a specific day, an alarm message for recommending the execution of the corresponding function to the user, and the alarm message is expressed by means of a character UI. Consequently, the user can use the wireless terminal with various functions more efficiently.

While the present invention has been shown and described with reference to certain exemplary embodiments thereof, it will be understood by those skilled in the art that various changes in form and detail may be made therein without departing from the scope and spirit of the invention as defined by the appended claims and their equivalents.

What is claimed is:

1. An apparatus for processing function events in a wireless terminal, the apparatus comprising:
a memory for storing a character UI image according to the function events of the wireless terminal;
an event collection section for collecting the function events occurring in the wireless terminal, and generating event messages for identifying the function events;
an agent control section comprising a plurality of specialists for processing the function events, determining a specialist corresponding to the event message among the specialists, selecting and outputting a character UI ID based on the function event of the determined specialist, and processing received user feedback information on a corresponding event according to the user feedback information; and
an agent expression section for outputting a character image and text, which correspond to the function event and the feedback information.

2. The apparatus as claimed in claim 1, wherein the agent control section determines the specialist corresponding to the event message among the specialists, sets an alarm event based on the function event of the determined specialist, and selects and outputs a character UI based on information regarding the alarm event when an occurrence time of the alarm event is reached.

3. The apparatus as claimed in claim 1, further comprising an event transfer section for transferring the function events collected by event collection section to the agent control section.

4. The apparatus as claimed in claim 1, further comprising a supervisor for, when more than two specialists are selected for one event, selecting a specialist most relevant to the event.

5. The apparatus as claimed in claim 1, wherein the function event comprises a communication function execution event, a message function execution event, a mail function execution event, a ringing sound function execution event, a morning call function execution event, and a program function execution event.

6. The apparatus as claimed in claim 1, wherein, when a message has been transmitted to a receiver more than a predetermined number of times within a specific time period in a cycle, the agent control section comprises a message transmission-recommendation alarm specialist for recommending message transmission to the receiver when a message has not been transmitted to the receiver within a specific time period in the next cycle.

7. The apparatus as claimed in claim 6, wherein the specific time period represents a time period from a first time, which is earlier than a time at which a message has been previously transmitted to the receiver, to a time at which a message has been transmitted to the receiver.

8. The apparatus as claimed in claim 6, wherein the specific time period represents a time period from a time at which a message has been previously transmitted to the receiver, to a second time later than a time at which a message has been transmitted to the receiver.

9. The apparatus as claimed in claim 6, wherein the specific time period represents a time period from a first time, which is earlier than a time at which a message has been previously transmitted to the receiver, to a second time later than a time at which a message has been transmitted to the receiver.

10. The apparatus as claimed in claim 6, wherein the agent control section transmits both a character UI ID based on a message transmission-recommendation alarm of the specialist and information on the corresponding receiver to the agent expression section, thereby controlling the agent expression section to output a character and text for recommending message transmission to the receiver.

11. The apparatus as claimed in claim 10, wherein the agent control section controls the agent expression section to output a selection button list together with the character and the text for recommending the message transmission to the receiver, and to output a character and text which correspond to feedback information generated by selecting a selection button.

12. The apparatus as claimed in claim 1, wherein, when mail has been transmitted to a receiver more than a predetermined number of times within a specific time period in a cycle, the agent control section comprises a mail transmission-recommendation alarm specialist for recommending mail transmission to the receiver when mail has not been transmitted to the receiver within a specific time period in each next cycle.

13. The apparatus as claimed in claim 12, wherein the specific time period represents one of a time period from a first time which is earlier than a time at which mail has been previously transmitted to the receiver to a time at which mail has been transmitted to the receiver, a time period from the time at which mail has been previously transmitted to the receiver to a second time later than the time at which mail has been transmitted to the receiver, and a time period from the first time to the second time.

14. The apparatus as claimed in claim 12, wherein the agent control section transmits both a character UI ID based on a mail transmission-recommendation alarm of the specialist and information on the corresponding receiver to the agent expression section, thereby controlling the agent expression section to output a character and text for recommending mail transmission to the receiver.

15. The apparatus as claimed in claim 14, wherein the agent control section controls the agent expression section to output a selection button list together with the character and the text for recommending the mail transmission to the receiver, and to output a character and a text corresponding to feedback information generated by selecting a selection button.

16. The apparatus as claimed in claim 1, wherein, when ringing sound has been changed more than a predetermined number of times within a specific time period in a cycle, the agent control section comprises a ringing sound change-recommendation alarm specialist for recommending a change of the ringing sound when the ringing sound has not been changed within a specific time period in each next cycle.

17. The apparatus as claimed in claim 16, wherein the specific time period represents one of a time period from a first time which is earlier than a time at which the ringing sound has been previously changed to a time at which the ringing sound has been changed, a time period from the time at which the ringing sound has been previously changed to a second time later than the time at which the ringing sound has been changed, and a time period from the first time to the second time.

18. The apparatus as claimed in claim 16, wherein the agent control section transmits both a character UI ID based on a ringing sound change-recommendation alarm of the specialist and information on the ringing sound to the agent expression section, thereby controlling the agent expression section to output a character and text for recommending the change of the ringing sound.

19. The apparatus as claimed in claim 18, wherein the agent control section controls the agent expression section to output a selection button list together with the character and the text for recommending the change of the ringing sound, and to output a character and text which correspond to feedback information generated by selecting a selection button.

20. A method for processing function events in a wireless terminal, the method comprising the steps of:
when function execution events occur in the wireless terminal, executing a corresponding function;
storing function execution information, which is generated during the execution of the corresponding function, in a function execution list;
analyzing the function execution list, and determining if the function has been executed more than a predetermined number of times within a specific time period in a cycle; and
when the function has been executed more than the predetermined number of times within the specific time period in each cycle, setting an alarm for recommending an execution of the corresponding function if the corresponding function is not executed within a specific time period in each next cycle.

21. The method as claimed in claim 20, wherein the function of the wireless terminal comprises a phone communication function, a message function, a mail function, an application program function, a ringing sound change function, and a morning call registration function.

22. The method as claimed in claim 20, wherein the function execution information comprises time information, day information and date information, which relate to an execution of a corresponding function, type information of a function, or supplementary information applied to an execution of a function.

23. The method as claimed in claim 20, wherein the specific time period represents one of a time period from a first time which is earlier than a final execution time of the corresponding function of the wireless terminal to an execution time of the corresponding function of the wireless terminal, a time period from the final execution time of the corresponding function of the wireless terminal to a second time later than the execution time of the corresponding function of the wireless terminal, and a time period from the first time to the second time.

24. A method for processing a function alarm event in a wireless terminal, the method comprising the steps of:
checking function types set in the alarm event when the alarm event occurs;
analyzing an execution history of the corresponding checked function and determining if the corresponding function has been executed within a specific time period; and
expressing a character and text for recommending an execution of the corresponding function when the corresponding function has not been executed within the specific time period.

25. The method as claimed in claim 24, wherein the alarm event corresponds to an alarm event for recommending the execution of the corresponding function when the corresponding function of the wireless terminal, which had been executed more than a predetermined number of times within a specific time period in a cycle, has not been executed within a specific time period in each next cycle.

26. The method as claimed in claim 24, further comprising the steps of:
expressing a selection button list together with the character and the text for recommending the execution of the corresponding function; and
expressing feedback information corresponding to the selected selection button when a selection button is selected from the selection button list.

27. The method as claimed in claim 26, wherein the step of expressing the feedback information comprises the sub-steps of:
expressing a smiling character and text which represent the approval of the execution of the corresponding function when a button for approving the execution of the corresponding function is selected from the selection button list; and
expressing a sorrowful character and a text which represent the rejection of the execution of the corresponding function when a button for rejecting the execution of the corresponding function is selected from the selection button list.

28. The method as claimed in claim 24, wherein the function set in the alarm event comprises a phone communication function, a message function, a mail function, an application program function, a ringing sound change function, and a morning call registration function.

29. The method as claimed in claim 24, wherein the execution history of the function comprises time information, day information and date information, which relate to an execution of a corresponding function, type information of a function, or supplementary information applied to an execution of a function.

30. The method as claimed in claim 24, wherein the specific time period represents one of a time period from a first time which is earlier than a final execution time of the corresponding function to an execution time of the corresponding function, a time period from the final execution time of the corresponding function to a second time later than the execution time of the corresponding function, and a time period from the first time to the second time.

31. The method as claimed in claim 24 or 27, wherein the expressed character and text disappear if a time period passes or a key is input.
